(19) United States
(12) Patent Application Publication
(10) Pub. No.: US 2003/0193988 A1
(43) Pub. Date: Oct. 16, 2003

(54) Method and apparatus for determining the concentration of components of molten baths

(76) Inventor: Calvin Bates, Monroeville, PA (US)

Correspondence Address: ALCOA INC, ALCOA TECHNICAL CENTER, 100 TECHNICAL DRIVE, ALCOA CENTER, PA, 15069-0001, US

(21) Appl. No.: 10/123,941

(22) Filed: Apr. 16, 2002

(51) Int. Cl. G01N 25/00; G01K 7/04

(52) U.S. Cl. 374/10; 374/179; 374/45

(57) ABSTRACT

A method of measuring the concentration of a molten bath component comprises the steps of placing a test sample in contact with the molten bath sample, measuring a change in temperature of that sample due to dissolution of the test sample, and determining the concentration of the component in that molten bath based on the change in sample temperature. The test sample can comprise alumina, and the molten bath can comprise a cryolite bath. The test sample can be placed in a probe chamber, which is then immersed in the molten bath, opened to permit the sample of the molten bath to enter the probe chamber, and closed prior to the step of measuring a change in temperature of the sample of the molten bath. An apparatus for measuring the concentration of the component in a molten bath is also disclosed.

### FIELD OF THE INVENTION

The present invention relates to testing of materials, and more particularly to methods and apparatus which utilize temperature measurements to determine the concentration of components of molten baths.

### BACKGROUND OF THE INVENTION

Aluminum is conventionally produced by smelting in a Hall bath. During the smelting operation, it is desirable to control parameters such as the temperature of the bath and the concentration of alumina in the bath. Typically, molten cryolite is sampled and the samples are analyzed in a laboratory using x-ray diffraction, pyrotitration, Lewis Acid, and/or Leco technology to characterize the chemistry of the molten bath. Such laboratory testing results in control measurements being made several hours after sampling, with little indication of current process conditions.

U.S. Pat. No. 6,220,748 discloses a method and apparatus for more timely and accurate measurement of material parameters in a molten cryolite bath. A test sensor measures the temperature of a sample of material as it is heated up and/or cooled down. A reference sensor is used to obtain differential temperature measurements as the temperature of the test sample is varied. A differential temperature trace is generated and analyzed in order to determine various characteristics of the material being tested. The sodium fluoride to aluminum fluoride ratio (NaF:AlF₃) and alumina concentration in a Hall bath aluminum smelting operation can be determined using the technique disclosed in U.S. Pat. No. 6,220,748. The bath temperature and liquidus temperature can also be measured and compared in order to determine the amount of superheat of the bath and to prevent the operation of smelters at higher temperatures than necessary.

Although the method and apparatus of U.S. Pat. No. 6,220,748 can measure the concentration of alumina in a Hall bath, there remains a need for a method and apparatus that can provide a more accurate result. Thus a need exists for accurately measuring concentrations of compounds in aluminum smelting baths.

### SUMMARY OF THE INVENTION

This invention provides a method of measuring a concentration of a component in a molten bath comprising the steps of placing a test sample in contact with a sample of the molten bath, measuring a change in temperature of the sample of the molten bath due to dissolution of the test sample, and determining the concentration of a component in the molten bath based on the change in temperature of the sample of the molten bath. The test sample can comprise alumina, and molten bath can comprise a cryolite bath. The test sample can be placed in a probe chamber, which is then immersed the molten bath, opened to permit the sample of the molten bath to enter the probe chamber, and closed prior to the step of measuring a change in temperature of the sample of the molten bath. The change in temperature of the sample of the molten bath can be measured by measuring a difference in temperature between the sample of molten bath and a reference sample of the molten bath.

The step of measuring the difference in temperature between the sample of molten bath and a reference sample of the molten bath can be accomplished by placing the test sample in a first probe chamber, immersing the first probe chamber and a second probe chamber in the molten bath, opening the first probe chamber to permit a first sample of the molten bath to enter the first probe chamber, closing the first probe chamber, opening the second probe chamber to permit a second sample of the molten bath to enter the second probe chamber, closing the second probe chamber, and measuring a difference in temperature between the first sample of the molten bath and the second sample of the molten bath.

The invention also encompasses an apparatus for measuring a concentration of a component in a molten bath comprising a probe for placing a test sample in contact with a test sample of the molten bath, means for measuring a change in temperature of the sample of the molten bath due to dissolution of the test sample, and means for determining a concentration of the component in the molten bath based on the change in temperature of the test sample of the molten bath. The test sample can comprises alumina and the molten bath can comprise a cryolite bath.

The probe can comprise a first probe chamber for containing the test sample, means for immersing the first probe chamber in the cryolite bath, and means for opening and closing the first probe chamber to collect the sample of the molten bath. The probe can alternatively comprise a first probe chamber, a second probe chamber, means for immersing the first probe and second probe chambers in the cryolite bath, and means for opening and closing the probe chambers to collect first and second samples.

This invention can provide timely measurements of alumina concentration in a Hall process which can be used to more closely control the processes.

### BRIEF DESCRIPTION OF THE DRAWINGS

FIG. 1 is a side view of a test probe constructed in accordance with the present invention;

FIG. 2 is another a side view of the test probe of FIG. 1 in the closed position;

FIG. 3 is a graph that illustrates a change in temperature that can occur during a measurement made in accordance with this invention;

FIG. 4 is an isometric view of a test sample container that was used as a basis for calculations of the response of the test probe under adiabatic conditions; and

FIGS. 5-10 are graphs of calculated temperature versus alumina concentrations.

### DETAILED DESCRIPTION OF THE INVENTION

The present invention provides a method and apparatus for determining the concentration of components of molten baths. During aluminum smelting operations, the ratio of certain constituents in the bath, e.g., the alumina (Al₂O₃) concentration may be determined.

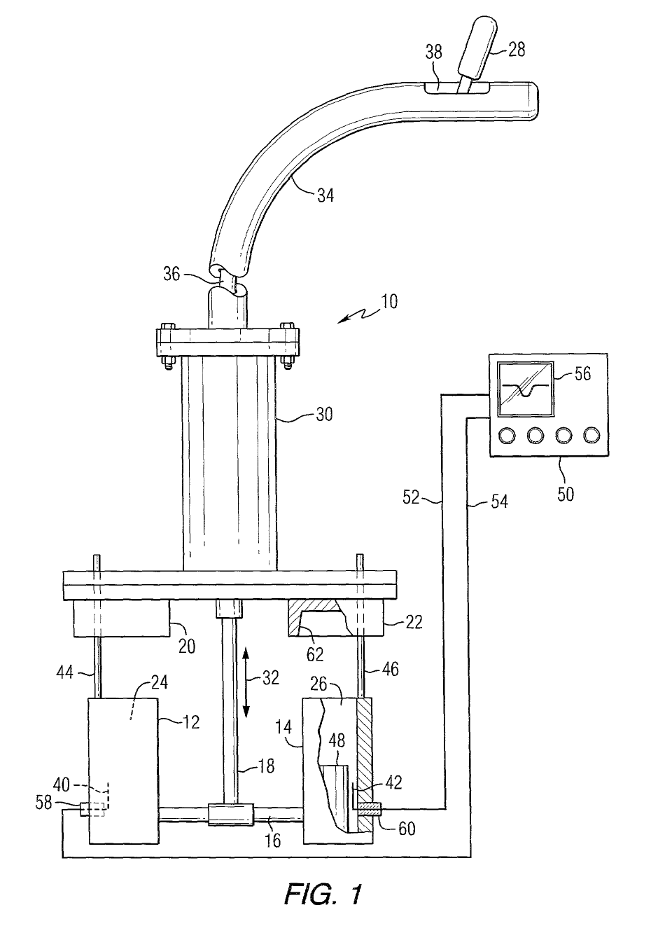

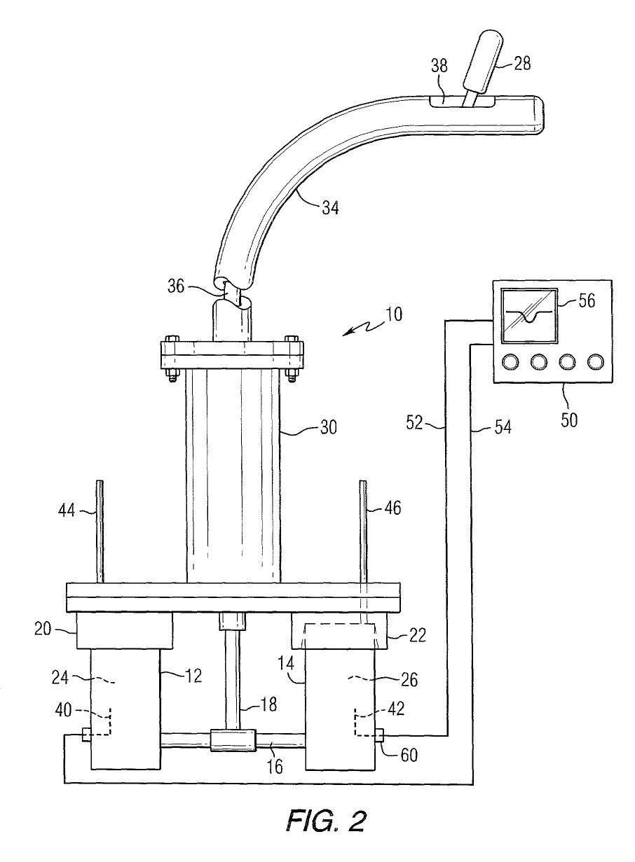

FIG. 1 illustrates a test probe 10 constructed in accordance with the invention. FIG. 2 illustrates the test probe of FIG. 1 in the closed position. The probe 10 includes first and second containers 12 and 14. The containers are connected to a support arm 16 by a moveable shaft 18.

The probe includes first and second end caps 20 and 22 for receiving open ends of the containers 12 and 14. The interiors of the containers form test chambers 24 and 26. The shaft 18 is coupled to an operating lever 28 through a spring loaded mechanism 30, such that movement of the operating lever causes the containers to move into or away from the caps as indicated by arrow 32. A handle 34 is used to position the containers in a bath. The lever 28 is coupled to the shaft 18 through a flexible shaft 36. A slot 38 in the handle allows movement of the lever. Each container contains a temperature measuring means in the form of a thermocouple 40 and 42.

Each container can firer include a guide rod 44 and 46 that passes through one of the caps. An alumina test sample 48 is placed in one of the containers. The alumina test sample can have a cylindrical shape as illustrated in FIG. 1, but the shape of the test sample is not important to the operation of the invention. The test sample should be sized to permit good contact with the bath sample, and can occupy, for example 50% of the volume of the test container. An analyzer 50 is electrically connected to the thermocouples in the test containers, by wires 52 and 54. In the embodiment shown in FIG. 1, the analyzer 50 includes a display 56 which shows temperature information obtained from the thermocouples. Thermocouple 40 serves as a reference thermocouple and extends into container 12. A refractory fitting 58 extends through a wall of the container 12 and surrounds an electrical lead 54 of the reference thermocouple 40. The wire 52 to the test thermocouple 42 extends through a fitting 60.

Each of the caps includes a tapered interior wall 62 the makes contact with an upper edge of the containers when the containers are in the closed position. The handle 34 may be any suitable length. For example, where the probe 10 is used for testing aluminum smelting baths, the arm 34 may preferably be from about 0.5 to about 10 feet in length.

The various components of the probe are made of any suitable materials. For example, the handle, containers, and caps, may be made of metal such as stainless steel, inconel, monel or aluminum. The fittings may be made of fiberfrax rope, or the like.

This invention utilizes the endothermic properties of the dissolution of the test sample in a sample of molten bath to determine the concentration of a component of the bath. To make the determination, the probe containers would initially be submerged into a molten bath in a closed position. Once the temperatures of the containers had stabilized to the temperature of the bath, the containers would be opened, permitting samples of the bath to enter the containers. Then the containers would be closed. Next the temperatures of the test sample of molten bath and the reference sample of molten bath within the containers would be monitored and the results analyzed to determine the concentration of the component of the bath. The containers would remain in the bath during measurement of the temperature change. However, they could be removed afterwards to investigate and/or characterize the difference between a saturated sample and the unsaturated bath. The use of that approach would conceivably serve as a check on the first measurement.

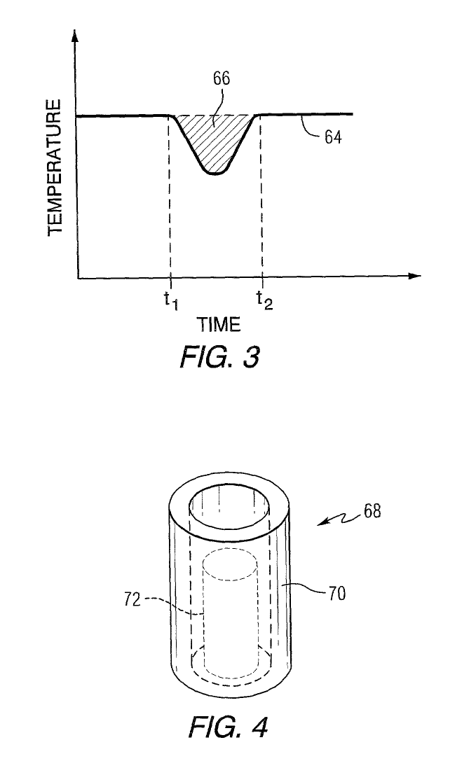

The difference in temperature between the test sample of the molten bath and the reference sample of the molten bath is recorded as a delta temperature ΔT, for example, using a meter comprising a conventional voltage amplification board and data logger. This can produce a plot of temperature versus time. FIG. 3 is a graph having a curve 64 that illustrates a negative deviation from the equilibrium of the sample and reference temperatures due to dissolution of the test sample. The area 66 represents the change in temperature that can be used to determine the alumina concentration in the bath. The area can be measured in various ways, such as by integrating over a fixed time span, or by integrating over a period having variable start and stop points that correspond to the temperature change crossing predetermined thresholds.

One embodiment of the invention includes a probe for determining the concentration of alumina in high temperature smelting cells based on measuring the energy involved in alumina dissolution. Such a probe may be particularly useful in measuring higher alumina concentrations, for example from 5.0 wt % through saturation.

A container having a fixed amount of alumina is covered or sealed and immersed into the molten bath of a Hall cell. A thermocouple imbedded in the container would log its temperature. Once the container reaches the temperature of the surrounding bath, the container would be opened to allow bath from the cell to contact the alumina in the container. The container would then be closed, and the temperature of the bath in the container would be recorded. The decrease in temperature recorded is a function of: a) how much alumina dissolved; and b) the starting alumina concentration in the bath. The recorded temperature is preferably a difference temperature between a test sample of molten bath surrounding the alumina test sample and a reference sample of molten bath.

Adiabatic calculations show that the calorimetric probe should have the temperature sensitivity needed for alumina measurements in the Hall bath from ˜5.0 wt % alumina to saturation. With a fixed test sample bath volume, adiabatic conditions, and temperature measurement accuracy of ±0.20° C., the optimum probe configuration should be able to determine the fraction of alumina saturation to within ±0.01% at the highest alumina concentration.

A bath test sample size of about 50 grams can provide close to the maximum measurable adiabatic temperature drop possible without freezing the test sample bath in the probe. The probe itself should be constructed of a light, inert material, having a low heat capacity and thermal conductivity. Boron nitride, because it is light and has a good thermal shock resistance, would be suitable as a probe material. The probe should collect bath samples of consistent or measurable mass. It is also preferable to minimize the length of time it takes to dissolve the alumina test sample.

The thermal conductivity of the probe containers will affect the rate of heat transfer to the probe, and thus, impact the probe's sensitivity to the alumina concentration in non-adiabatic conditions. The thermal conductivity of the probe, however, will also likely determine how long it will take to heat the probe to measure temperature. A compromise between the time to heat the probe, and the rate of heat transfer during the measurement, will have to be made.

The amount of bath used in the calorimetric device, the amount of excess and dissolved (i.e. reaction saturation) alumina, the mass and heat capacity of the container holding the bath and alumina, the heat of saturation of the alumina, and the temperature measurement reproducibility and accuracy, all affect the sensitivity of a calorimetric measurement held adiabatically. If the device cannot be held adiabatically, the thermal conductivity of the container and the heat transfer coefficient of the bath to the container become important as well.

FIG. 4 shows an isometric view of a probe test chamber 68 used to calculate simulated probe measurements. It includes of a hollow cylinder 70 of insulating material (either alumina or boron nitrde). A 5 gram mass test sample of alumina 72 is located in the cylinder, and cylinder and the alumina test sample would be brought to the temperature of the bath. Once at bath temperature, a fixed volume of bath would be added to the cylinder, which would then be covered and/or sealed. The probe, bath, and alumina would then be held adiabatically while the temperature of the probe is recorded.

The calculations presented here give the adiabatic temperature change in the probe that is expected, for the given starting alumina concentration, bath sample volume, and container material. Data used in these calculations are given in Table I.

TABLE I
Physical Properties Used In Calculations

| | |
|---|---|
| Starting alumina concentration (wt %) | 5, 6, 7, and 8 |
| Saturation alumina concentration (wt %) | 8.0 |
| Heat capacity of the bath (kJ/gm C) | 0.00164 |
| Heat capacity of alumina (kJ/gm C) | 0.001236 |
| Heat capacity of BN 9 kJ/gm C) | 0.001712 |
| Mass of alumina container (gms) | 115 |
| Mass of BN container (gms) | 64 |
| Mass of alumina for dissolving | 5.0 |
| Constant Heat of Solution (kJ/gm C) | 146 |
| Constant Heat of Solution (kJ/gm C) | 146 @ 5.0 wt % alumina |
| | 110 @ 6.0 wt % alumina |
| | 80 @ 7.0 wt % alumina |
| | 0 @ 8.0 wt % alumina |

Operation of the probe was evaluated under four scenarios: (I) dissolving a fixed amount of alumina with constant heat of solution; (II) dissolving a fixed amount of alumina with variable heat of solution; (III) dissolving alumina to saturation with constant heat of solution; and (IV) dissolving alumina to saturation with variable heat of solution. One weight percent was used for the fixed amount of alumina being dissolved. The results for each scenario are presented below.

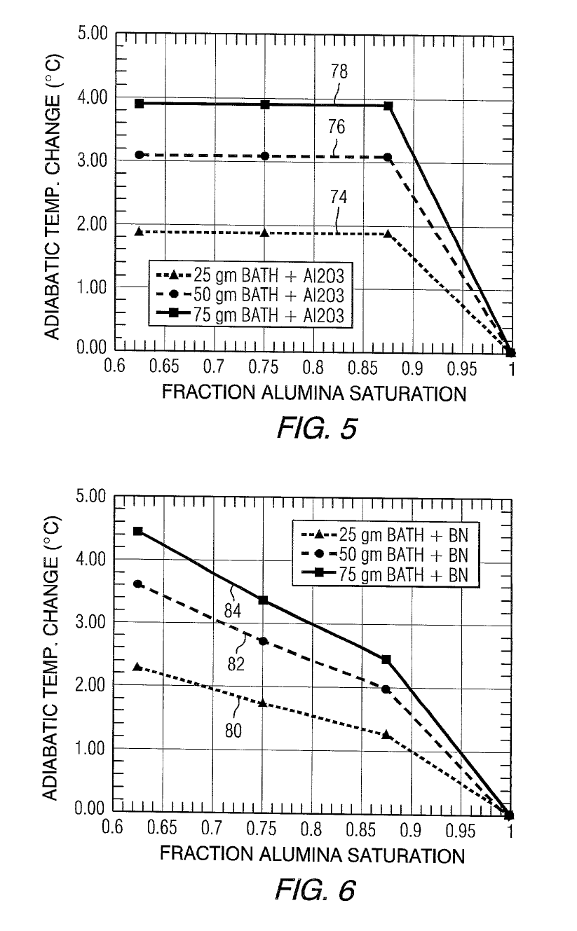

Scenario I: Dissolving A Fixed Amount of Alumina With Constant Heat of Solution. If the heat of solution is constant, right up to alumina saturation, and the fixed amount of alumina dissolved is 1.0 wt %, there is no sensitivity at all to alumina concentration until the alumina concentration is within 1.0 wt % of saturation. Within 1.0% of alumina saturation, the probe would give the same sensitivity to alumina concentration as Scenario III discussed below. Because this option has no sensitivity to alumina concentration below 1.0 wt % below saturation, it is not optimal. The expected temperature response to an adiabatic calorimetric probe designed for this scenario is shown in FIG. 5 for an alumina container, where line 74 assumes a 25 gm bath sample, line 76 assumes a 50 gm bath sample, and line 78 assumes a 75 gm bath sample.

Scenario II: Dissolving A Fixed Amount of Alumina With Variable Heat of Solution. When the starting alumina level in the bath is within 1.0 wt % of saturation, this scenario gives the same sensitivity to alumina concentration as scenario IV discussed below. Because the heat of solution decreases with alumina content, the sensitivity of the temperature reading to alumina concentration within 1.0% of saturation would be less than in scenario I or III. As shown in FIG. 6, for a boron nitride container, the temperature response of this probe is also less sensitive to alumina content of the bath than scenarios II or IV, until the alumina content of the bath is within 1.0 wt % of saturation (0.875 fraction of saturated) where the sensitivity becomes identical to scenario IV. In FIG. 6, line 80 assumes a 25 gm bath sample, line 82 assumes a 50 gm bath sample, and line 84 assumes a 75 gm bath sample.

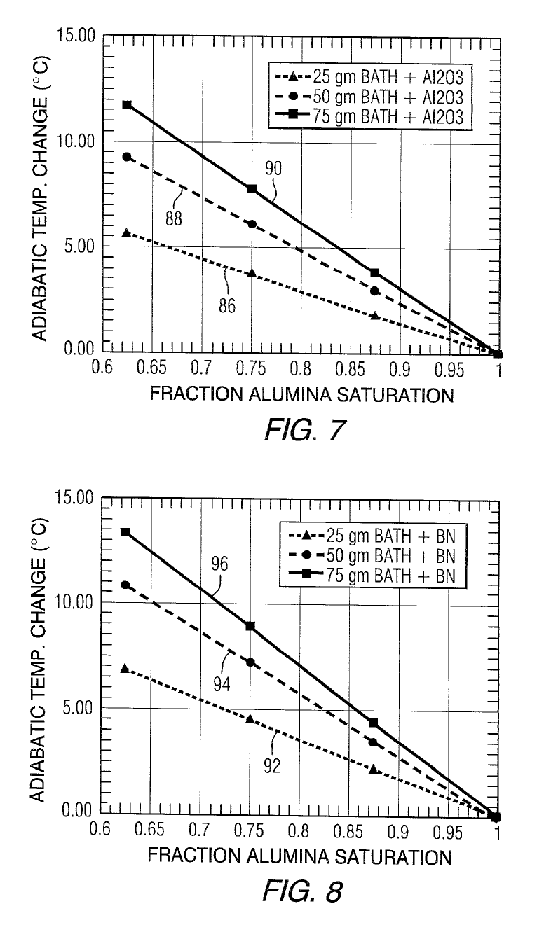

Scenario III: Dissolving Alumina to Saturation With Constant Heat of Solution. FIG. 7 shows the adiabatic temperature drop expected in an alumina container, for various starting bath alumina contents and bath sample volumes. In FIG. 7, line 86 assumes a 25 gm bath sample, line 88 assumes a 50 gm bath sample, and line 90 assumes a 75 gm bath sample. FIG. 8 shows the same results assuming a boron nitride container. In FIG. 8, line 92 assumes a 25 gm bath sample, line 94 assumes a 50 gm bath sample, and line 96 assumes a 75 gm bath sample. The expected temperature drops all appear significant enough to be able to be measured, and have reasonable sensitivity to the bath alumina content.

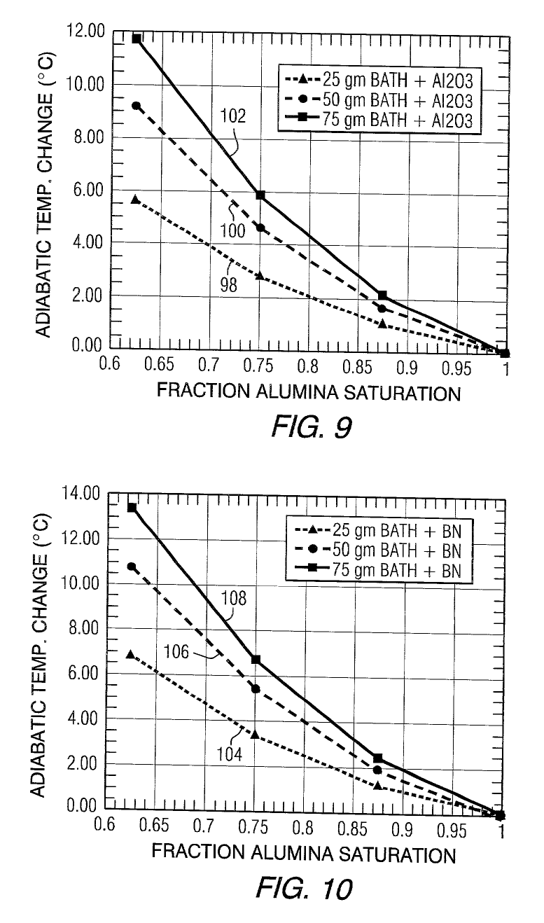

Scenario IV: Dissolving Alumina to Saturation With A Variable Heat of Solution. FIG. 9 shows the adiabatic temperature drop expected, as a function of the starting bath volume held in an alumina container, for various starting alumina contents. In FIG. 9, line 98 assumes a 25 gm bath sample, line 100 assumes a 50 gm bath sample, and line 102 assumes a 75 gm bath sample. FIG. 10 shows the same results assuming a boron nitride container. In FIG. 10, line 104 assumes a 25 gm bath sample, line 106 assumes a 50 gm bath sample, and line 108 assumes a 75 gm bath sample. This scenario shows greater temperature sensitivity to alumina content at lower alumina concentrations that scenario III, but less sensitivity than scenario III at higher alumina contents.

It should be noted that whether the heat of the alumina solution changes with alumina content or not is not something that can be controlled. The above scenarios show that a reasonable temperature sensitivity for an adiabatic calorimetric alumina probe is expected. The calculations also show that in either scenario, the probe will likely be more sensitive to the molten bath volume than it will be to temperature measurement.

The results presented above were based on the assumption that the probe could be maintained adiabatic throughout each measurement. It is highly improbable that an adiabatic condition could be maintained in normal circumstances. Three factors will determine the magnitude of non-adiabatic conditions on the measurement: (1) how quickly the alumina dissolves in the bath sample; (2) the thermal conductivity of the container and its thickness; and (3) the heat transfer coefficient from the bath to the container and the container's surface area.

The potential impact of these factors could be evaluated in a transient computer model. Generally, though, the faster the alumina dissolves, the lower the thermal conductivity of the container, and the lower its heat transfer coefficient and its surface area, the greater the probe sensitivity to alumina content.

It should be possible to dissolve the alumina in a 5-10 minute time frame. For a ceramic container, such as alumina or boron nitride, it is likely that conduction of heat through the container, rather than heat transfer from the bath to the surface of the container, will be the rate determining heat transfer mechanism. It is estimated that ˜4×10-7 kJ/cm sec C of heat could be conducted through an alumina container. If the walls of the container are 0.5 cm thick, it could take many seconds to transfer the 0.5 to 2.0 kJ of energy to be consumed by the alumina dissolution. A low probe thermal conductivity, however, will also increase that time it takes to bring the probe up to bath temperature prior to beginning the measurement.

This suggests that an optimally designed probe would use a container that has: (1) a low heat capacity times mass; (2) thermal shock resistance; (3) a design that allows uniform and consistent bath sample masses to be obtained; and (4) a low thermal conductivity.

If the probe is calibrated to measure fraction saturation, rather than alumina content in weight percent, it will be insensitive to changes in bath ratio and temperature, as long as those changes do not dramatically impact the heat of solution of the alumina.

The present invention thus provides the ability to measure alumina concentration on a real-time basis for improved process control, thereby resulting in increased efficiency of aluminum production. The temperature and time of dissolution of an alumina test sample in a sample of a Hall bath are used to indicate the amount of alumina that is dissolved in the bath. This information can be used to determine how much more alumina is needed to keep the pot operating as efficiently as possible. The method and apparatus of the invention may be used to test other types of materials. For example, other types of molten metals may be analyzed.

One embodiment of the invention uses differential thermal analysis (DTA) to measure the amount of alumina in a Hall bath by using the energy and time of dissolution of a known amount of smelting grade alumina in a Hall bath at process temperatures. The DTA process uses a test sample container and a reference container.

While particular examples of this invention have been described above for purposes of illustration, it will be evident to those skilled in the art that numerous variations of the details of the present invention may be made without departing from the invention as defined in the appended claims.

What is claimed is:

1. A method of measuring a concentration of a component in a molten bath comprising the steps of:
placing a test sample in contact with a sample of the molten bath;
measuring a change in temperature of the sample of the molten bath due to dissolution of the test sample; and
determining a concentration of a component in the molten bath based on the change in temperature of the sample of the molten bath.

2. The method of clam 1, wherein the test sample comprises alumina, and wherein the molten bath comprises a cryolite bath.

3. The method of clam 1, wherein the step of placing a test sample in contact with the sample of the molten bath comprises the steps of:
placing the test sample in a probe chamber;
immersing the probe chamber into the molten bath;
opening the probe chamber to permit the sample of the molten bath to enter the probe chamber; and
closing the probe chamber prior to the step of measuring a change in temperature of the sample of the molten bath.

4. The method of clam 1, wherein the step of measuring a change in temperature of the sample of the molten bath due to dissolution of the test sample comprises the steps of:
measuring a difference in temperature between the sample of molten bath and a reference sample of the molten bath.

5. The method of clam 4, wherein the step of measuring the difference in temperature between the sample of molten bath and a reference sample of the molten bath comprises the steps of:
placing the test sample in a first probe chamber;
immersing the first probe chamber and a second probe chamber in the molten bath;
opening the first probe chamber to permit a first sample of the molten bath to enter the first probe chamber;
closing the first probe chamber;
opening the second probe chamber to permit a second sample of the molten bath to enter the second probe chamber;
closing the second probe chamber; and
measuring a difference in temperature between the first sample of the molten bath and the second sample of the molten bath.

6. The method of clam 1, wherein the step of measuring a change in temperature of the sample of the molten bath due to dissolution of the test sample comprises the step of measuring a difference in temperature between the temperature of the first sample of the molten bath and the temperature of a second sample of the molten bath; and wherein the step of determining a concentration of the component in the molten bath based on the change in temperature of the sample of the molten bath comprises the step of integrating the difference in temperature over a predetermined time interval.

7. The method of clam 1, wherein the step of measuring a change in temperature of the sample of the molten bath due to dissolution of the test sample comprises the step of measuring a difference in temperature between the temperature of the first sample of the molten bath and the temperature of a second sample of the cryolite bath; and wherein the step of determining a concentration of the component in the molten bath based on the change in temperature of the sample of the molten bath comprises the step of integrating the difference in temperature over a time interval determined by points where the difference in temperature exceeds first and second threshold levels.

8. An apparatus for measuring a concentration of a component in a molten bath comprising:
a probe for placing a test sample in contact with a test sample of the molten bath;
means for measuring a change in temperature of the sample of the molten bath due to dissolution of the test sample; and
means for determining a concentration of the component in the molten bath based on the change in temperature of the test sample of the molten bath.

9. The apparatus of claim 8, wherein the test sample comprises alumina and wherein the molten bath comprises a cryolite bath.

10. The apparatus of claim 8, wherein the probe comprises:
a first probe chamber for containing the test sample;
means for opening and closing the first probe chamber to collect the sample of the molten bath.

11. The apparatus of claim 8, wherein the means for measuring a change in temperature of the sample of the molten bath due to dissolution of the test sample comprises:
a first thermocouple for measuring a temperature of the sample of molten bath.

12. The apparatus of claim 8, wherein the means for determining a concentration of the component in the molten bath based on the change in temperature of the sample of the molten bath comprises:
means for measuring the difference in temperature between the sample of molten bath and a reference sample of the molten bath.

13. The apparatus of claim 8, wherein the probe comprises:
a first probe chamber;
a second probe chamber;
means for immersing the first probe chamber and a second probe chamber in the cryolite bath; and
means for opening and closing the probe chambers to collect a first sample of the cryolite bath in the first probe chamber, and to collect a second sample of the cryolite bath in the second probe chamber.

14. The apparatus of claim 8, wherein the means for determining a concentration of the component in the molten bath based on the change in temperature of the sample of the molten bath comprises:
means for measuring the difference in temperature between the sample of molten bath and a reference sample of the molten bath.

15. The apparatus of claim 8, wherein means for determining a concentration of the component in the molten bath based on the change in temperature of the sample of the molten bath comprises:
an analyzer for integrating a difference in temperature between the test sample of molten bath and a reference sample of molten bath.

16. The apparatus of claim 8, wherein means for measuring a change in temperature of the sample of the molten bath comprises:
a thermocouple extending into an interior volume of a test sample container.
